(19) United States
(12) Patent Application Publication
(10) Pub. No.: US 2024/0334906 A1
(43) Pub. Date: Oct. 10, 2024

(54) SYSTEM FOR AUTONOMOUS TRAINING AND ENRICHMENT OF ANIMALS

(71) Applicant: Porter Al Labs, Inc., Oakland, CA (US)

(72) Inventors: Karthik Arumugham, Portland, OR (US); Scarlett Linnhe Trillia, Oakland, CA (US)

(73) Assignee: Porter Al Labs, Inc., Oakland, CA (US)

(21) Appl. No.: 18/628,603

(22) Filed: Apr. 5, 2024

Related U.S. Application Data
(60) Provisional application No. 63/494,754, filed on Apr. 6, 2023.

(51) Int. Cl. A01K 15/02; A01K 27/00; A01K 29/00

(52) U.S. Cl. CPC A01K 15/022; A01K 27/001; A01K 29/005

(57) ABSTRACT

A system for autonomously training an animal is provided, the system comprising an input device comprising one or more sensors for monitoring an animal during a training session. The input device is configured to communicate with a processing system. The system is further configured to: receive a first set of data from the input device, transmit the first set of data to the processing system, wherein the processing system is configured with a first machine learning model trained to detect the performance of a first behavior in the first set of data; receive a signal from the processing system comprising a determination from the first machine learning model that the first behavior has been performed by the animal; and upon receipt of the signal from the processing system, cause a reward device to provide one or more of audible feedback or a reward for the animal.

### CROSS-REFERENCE TO RELATED APPLICATIONS

This application claims priority to and the benefit of U.S. Provisional Patent Application No. 63/494,754, filed Apr. 6, 2023, the entire contents of which are hereby incorporated by reference.

### FIELD

The present disclosure generally relates to animal training systems. More particularly, the present disclosure relates to implementing systems and methods for autonomous training and enrichment of animals.

### BACKGROUND

For animals such as dogs, a combination of physical and mental engagement is essential to the happiness and well-being of the animal. Many people may desire the companionship that derives from keeping an animal as a pet, but many people also have busy lives that may prevent them from providing an animal with the proper amount of physical and mental engagement that the animal needs. Further, training an animal manually can be a difficult, time-consuming process, especially if the animal is to be trained as a service animal or working animal.

### SUMMARY

Described are systems and methods for autonomous training and enrichment of animals. The systems and methods described herein may provide an animal with an additional source of physical and mental engagement that can increase the animal's happiness while making training and engagement with the animal easier for humans.

For example, a system may include an input device which may be a device that can be used to monitor the behavior of an animal using one or more sensors. The input device may be a satellite unit, which may be mounted to a wall or installed in an area where an animal is to be trained. The input device may be a wearable device that can be worn by an animal such as a dog. The wearable device may be, for example, an entire collar, an entire harness, or a modular device to be attached to an existing collar or harness. Like the satellite unit, the wearable device may include one or more sensors. The one or more sensors may include, for example, a gyroscope, an accelerometer, a magnetometer, an inertial measurement unit (IMU), a microphone, a speaker, a camera, a time-of-flight (ToF) sensor, or a global positioning system (GPS).

The system may include multiple input devices, such as both the wearable device and the satellite unit. The wearable device may be configured to communicate with the satellite unit, such that the sensors in the wearable device and the satellite unit can monitor the animal during a training session and collect data during the training session which may capture the performance of one or more behaviors by the animal during the training session. For example, during a training session, an animal such as a dog may be wearing the wearable device while standing near the satellite unit. The satellite unit may observe, using the camera, time-of-flight sensor, etc., a dog performing one or more behaviors. The satellite unit and the wearable device may also detect a pose, a linear acceleration, an angular velocity, a location, a sound, an image, or magnetic field information while the dog is performing one or more behaviors.

The input device, i.e. the satellite unit or the wearable device, may be configured to communicate with a processing system, which may be external to the system or may be integrated within the input device. The input device may be configured to transmit data collected by the one or more sensors perceiving the dog during the training session to the processing system for analysis.

The processing system may be configured to analyze the data collected during the training session using one or more machine learning models. The processing system may be configured with a machine learning model that is trained to detect the performance of a behavior in the data collected during the training session by the satellite unit and the wearable device. For example, if the behavior is a “sit,” the machine learning model may be trained from training data comprising one or more of an animal pose, an animal linear acceleration, an animal angular velocity, an animal location, an animal sound, an animal image, or animal magnetic field information collected from various animals, i.e. various other dogs, while performing a “sit” such that the machine learning model is trained to recognize a “sit” in similar types of data.

The system may also be configured to communicate with a reward device configured to dispense a reward for the animal upon the completion of a desired behavior. Upon analyzing the data collected during the training session and determining that the dog has performed a “sit,” for example, using the machine learning model, the system may send a signal indicating that the behavior has been performed to the reward device. Upon receiving the signal from the system, the reward device may provide audible feedback such as praise, or a reward such as a treat or a toy to reinforce the desired behavior. As will be further explained, the system may implement various methods of behavioral shaping or generate custom training plans for an animal using multiple machine learning models in a similar manner as described above.

An example aspect includes a system for autonomously training an animal, comprising a smart wearable device, a satellite unit, a dispenser, a memory, and one or more processors coupled to the memory. The one or more processors configured to receive data from the smart wearable device, the satellite unit, or the dispenser. The one or more processors is further configured to identify, based on the data from the smart wearable device, the satellite unit, or the dispenser, and an output of a machine learning model, a behavior of the animal. The one or more processors is further configured to cause the dispenser to release a reinforcer for the animal based on the behavior or provide one or more instructions to the animal to perform one or more additional behaviors.

Another example aspect includes a method for autonomously training an animal, comprising receiving data from a smart wearable device, a satellite unit, or a dispenser. The method further includes identifying, based on the data from the smart wearable device, the satellite unit, or the dispenser, and an output of a machine learning model, a behavior of the animal. The method further includes causing the dispenser to release a reinforcer for the animal based on the behavior or provide one or more instructions to the animal to perform one or more additional behaviors.

Another example aspect includes a system for autonomously training an animal comprising a smart wearable device, a satellite unit, and a dispenser. The system includes means for receiving data from the smart wearable device, the satellite unit, or the dispenser. The system further includes means for identifying, based on the data from the smart wearable device, the satellite unit, or the dispenser, and an output of a machine learning model, a behavior of the animal. The system further includes means for causing the dispenser to release a reinforcer for the animal based on the behavior or provide one or more instructions to the animal to perform one or more additional behaviors.

Another example aspect includes a computer-readable medium having instructions stored thereon for autonomously training an animal, wherein the instructions are executable by a processor to receive data from a smart wearable device, a satellite unit, or a dispenser. The instructions are further executable to identify, based on the data from the smart wearable device, the satellite unit, or the dispenser, and an output of a machine learning model, a behavior of the animal. The instructions are further executable to cause the dispenser to release a reinforcer for the animal based on the behavior or provide one or more instructions to the animal to perform one or more additional behaviors.

Another example aspect includes a system for autonomously training an animal, comprising a smart wearable device, a satellite unit, a dispenser, a memory, and one or more processors coupled to the memory. The one or more processors configured to receive data from the smart wearable device, the satellite unit, or the dispenser over multiple time periods. The one or more processors is further configured to generate, based on the data from the smart wearable device, the satellite unit, or the dispenser, and an output of a machine learning model, one or more training plans for the animal. The one or more processors is further configured to initiate a training session of a training plan from the one or more training plans.

Another example aspect includes a method for autonomously training an animal, comprising receiving data from a smart wearable device, a satellite unit, or a dispenser over multiple time periods. The method further includes generating, based on the data from the smart wearable device, the satellite unit, or the dispenser, and an output of a machine learning model, one or more training plans for the animal. The method further includes initiating a training session of a training plan from the one or more training plans.

Another example aspect includes a system for autonomously training an animal comprising a smart wearable device, a satellite unit, and a dispenser. The system includes means for receiving data from a smart wearable device, a satellite unit, or a dispenser over multiple time periods. The system includes means for generating, based on the data from the smart wearable device, the satellite unit, or the dispenser, and an output of a machine learning model, one or more training plans for the animal. The system includes means for initiating a training session of a training plan from the one or more training plans.

Another example aspect includes a computer-readable medium having instructions stored thereon for autonomously training an animal, wherein the instructions are executable by a processor to receive data from the smart wearable device, the satellite unit, or the dispenser over multiple time periods. The instructions are further executable to generate, based on the data from the smart wearable device, the satellite unit, or the dispenser, and an output of a machine learning model, one or more training plans for the animal. The instructions are further executable to initiate a training session of a training plan from the one or more training plans.

Another example aspect includes a system for autonomously training an animal, comprising a smart wearable device, a satellite unit, a dispenser, a memory, and one or more processors coupled to the memory. The one or more processors configured to receive data from the smart wearable device, the satellite unit, or the dispenser. The one or more processors is further configured to identify, based on the data, a comfort level of the animal. The one or more processors is further configured to initiate, based on the comfort level, a comforting resolution for the animal.

Another example aspect includes a method for autonomously training an animal, comprising receiving data from a smart wearable device, a satellite unit, or a dispenser. The method further includes identifying, based on the data, a comfort level of the animal. The method further includes initiating, based on the comfort level, a comforting resolution for the animal.

Another example aspect includes a system for autonomously training an animal comprising a smart wearable device, a satellite unit, and a dispenser. The system includes means for receiving data from a smart wearable device, a satellite unit, or a dispenser. The system includes means for identifying, based on the data, a comfort level of the animal. The system includes means for initiating, based on the comfort level, a comforting resolution for the animal.

Another example aspect includes a computer-readable medium having instructions stored thereon for autonomously training an animal, wherein the instructions are executable by a processor to receive data from a smart wearable device, a satellite unit, or a dispenser. The instructions are further executable to identify, based on the data, a comfort level of the animal. The instructions are further executable to initiate, based on the comfort level, a comforting resolution for the animal.

In some examples, a system for autonomously training an animal includes an input device comprising one or more sensors, wherein the input device is configured to communicate with a processing system. In some examples, the input device comprises one or more sensors. In some examples, the system is further configured to receive a first set of data from the input device, the first set of data comprising one or more of a pose, a linear acceleration, an angular velocity, a location, a sound, an image, a video, or magnetic field information of the animal. In some examples, the system is further configured to transmit the first set of data to the processing system, wherein the processing system is configured with a first machine learning model trained to detect the performance of a first behavior in the first set of data, wherein the machine learning model is trained from training data comprising one or more of an animal pose, an animal linear acceleration, an animal angular velocity, an animal location, an animal sound, an animal image, or animal magnetic field information corresponding to the first behavior. In some examples, the system is further configured to receive a signal from the processing system comprising a determination from the first machine learning model that the first behavior has been performed by the animal based on the first set of data; and, upon receipt of the signal from the processing system, cause a reward device to provide one or more of audible feedback or a reward for the animal.

In some examples, the input device comprises a wearable device.

In some examples, the system comprises the reward device.

In some examples, the reward comprises one or more of a food reward or a toy reward.

In some examples, the audible feedback comprises one or more instructions to the animal to perform one or more additional behaviors.

In some examples, the audible feedback comprises praise for the animal.

In some examples, the one or more sensors of the input device comprise at least one of a gyroscope, an accelerometer, a magnetometer, an inertial measurement unit (IMU), a microphone, a speaker, a camera, a time-of-flight (ToF) sensor, or a global positioning system (GPS).

In some examples, the one or more sensors of the input device comprise an attitude and heading reference system (AHRS).

In some examples, the system is further configured to receive a second set of data from the input device, the second set of data comprising one or more of a second pose, a second linear acceleration, a second angular velocity, a second location, a second sound, a second image, a second video, or second magnetic field information of the animal. In some examples, the system is further configured to transmit the second set of data to the processing system, wherein the processing system is configured with a second machine learning model trained to detect the performance of a second behavior in the second set of data, wherein the machine learning model is trained from training data comprising one or more of an animal pose, an animal linear acceleration, an animal angular velocity, an animal location, an animal sound, an animal image, or animal magnetic field information corresponding to the second behavior. In some examples, the system is further configured to receive a signal from the processing system comprising a determination from the second machine learning model that the second behavior has been performed by the animal based on the first set of data; and upon receipt of the signal from the processing system, cause the reward device to provide an output comprising one or more of audible feedback or a reward.

In some examples, the system comprises the processing system.

In some examples, the input device comprises the processing system.

In some examples, one or more of the input device or the processing system are configured to communicate over a wireless network.

In some examples, the wireless network is a mesh-based wireless network.

In some examples, the processing system comprises a cloud-based processor.

In some examples, the processing system comprises a computer connected to the wireless network.

In some examples, the processing system is configured to store one or more of the first set of data or data comprising the determination by the machine learning model that the first behavior has been performed by the animal to a profile associated with the animal.

In some examples, a method for autonomously training an animal comprises: monitoring the animal using one or more sensors; receiving a first set of data from the one or more sensors, the first set of data comprising one or more of a pose, a linear acceleration, an angular velocity, a location, a sound, an image, a video, or magnetic field information of the animal; inputting the first set of data into a first machine learning model, wherein the first machine learning model is trained to detect the performance of a first behavior in the first set of data from training data comprising one or more of an animal pose, an animal linear acceleration, an animal angular velocity, an animal location, an animal sound, an animal image, or animal magnetic field information corresponding to the first behavior; determining that the first behavior has been performed by the animal from the first set of data using the first machine learning model; upon determining that the first behavior has been performed by the animal, providing an output comprising one or more of audible feedback or a reward.

In some examples, the reward comprises one or more of a food reward or a toy reward.

In some examples, the audible feedback comprises one or more instructions to the animal to perform one or more additional behaviors.

In some examples, the audible feedback comprises praise for the animal.

In some examples, the one or more sensors comprise at least one of a gyroscope, an accelerometer, a magnetometer, an inertial measurement unit (IMU), a microphone, a speaker, a camera, a time-of-flight (ToF) sensor, or a global positioning system (GPS).

In some examples, the method further comprises receiving a second set of data from the one or more sensors, the second set of data comprising a second pose, a second linear acceleration, a second angular velocity, a second location, a second sound, a second image, a second video, or second magnetic field information of the animal; inputting the second set of data into a second machine learning model, wherein the second machine learning model is trained to detect the performance of a second behavior in the second set of data from training data comprising one or more of an animal pose, an animal linear acceleration, an animal angular velocity, an animal location, an animal sound, an animal image, or animal magnetic field information corresponding to the second behavior; determining that the second behavior has been performed by the animal from the second set of data using the second machine learning model; and upon determining that the second behavior has been performed by the animal, providing an output comprising one or more of audible feedback or a reward.

In some examples, the method further comprises determining that the first behavior has not been performed by the animal from the first set of data using the first machine learning model; and upon determining that the first behavior has not been performed by the animal, administering a correction to the animal.

In some examples, the correction is one or more of an audible correction or a visual correction.

In some examples, the method further comprises determining that the first behavior has been performed by the animal from the first set of data comprises determining that a threshold portion of the first behavior has been performed by the animal using the first machine learning model.

In some examples, the threshold portion of the first behavior comprises at least one of a threshold pose, a threshold linear acceleration, a threshold angular velocity, a threshold location, a threshold sound, a threshold image, or threshold magnetic field information.

In some examples, the method further comprises generating, based on the first set of data, one or more training plans for the animal using a third machine learning model, wherein the third machine learning model is trained to generate a training plan from training data comprising one or more of animal training plans or published behavioral science knowledge; and providing an output comprising the one or more training plans.

In some examples, the method further comprises selecting, based on the first set of data, one or more pre-programmed training plans for the animal using a third machine learning model, wherein the third machine learning model is trained from training data comprising one or more of animal training plans or published behavioral science knowledge; and providing an output comprising the one or more pre-programmed training plans.

In some examples, the method further comprises determining a first routine score for the animal based on the first set of data; determining a second routine score for the animal based on an external set of data, wherein the external set of data comprises one or more of lab reports, veterinary reports, or trainer reports; aggregating the first and second routine scores into an aggregate routine score; and selecting, based on the aggregate routine score, one or more training plans for the animal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1A illustrates an animal wearing an input device, in accordance with various aspects of the present disclosure.

FIG. 1B illustrates an exploded view of an input device, in accordance with various aspects of the present disclosure.

FIG. 2A illustrates a perspective view of an input device, in accordance with various aspects of the present disclosure.

FIG. 2B illustrates a perspective view of an input device sliding off of a mounting bracket, in accordance with various aspects of the present disclosure.

FIG. 2C illustrates an exploded view of an input device, in accordance with various aspects of the present disclosure.

FIG. 3 illustrates an arrangement of a system for autonomously training an animal, accordance with various aspects of the present disclosure.

FIG. 4 illustrates components of an exemplary system for autonomously training an animal, in accordance with various aspects of the present disclosure.

FIG. 5 illustrates an exemplary method for autonomously training an animal, in accordance with various aspects of the present disclosure.

FIG. 6 illustrates a computer, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Described are systems and methods for autonomous training and enrichment of animals. In some embodiments, a system may include an input device which may be a device that can be used to monitor the behavior of an animal during a training session using one or more sensors. The one or more sensors may include a gyroscope, an accelerometer, a magnetometer, an inertial measurement unit (IMU), a microphone, a speaker, a camera, a time-of-flight (ToF) sensor, and/or a global positioning system (GPS).

In some embodiments, the input device may be a wearable device, which may be a collar, harness, or a modular device configured to be attached to a collar or harness. The wearable device may comprise one or more of the same sensors as the satellite unit. The wearable device may be worn by an animal during a training session such that data can be collected from the one or more sensors during the training session as the animal performs one or more behaviors. In some embodiments, the input device may be fixed to a wall or other part of a house, training facility, etc.

In some embodiments, the input device may receive data from the one or more sensors during the training session, the data comprising one or more of a pose, a linear acceleration, an angular velocity, a location, a sound, an image, a video, or magnetic field information of the animal. This data collected by the sensors may be used by the system to determine whether an animal has performed a desired behavior during a training session.

In some embodiments, the system may include multiple input devices which may be configured to communicate with one another and with a processing system. The input devices may transmit the sensor data to the processing system. The processing system may be configured with a machine learning model trained to detect the performance of a behavior in the data collected by the sensors during the training session. The machine learning model may be trained to detect the performance of a behavior from training data comprising one or more of an animal pose, an animal linear acceleration, an animal angular velocity, an animal location, an animal sound, an animal image, or animal magnetic field information corresponding to the behavior.

In some embodiments, the processing system may be configured to transmit a signal comprising a determination from the machine learning model that the behavior has been performed by the animal to the system. Upon receipt of the signal from the processing system, the system may cause a reward device to provide one or more of audible feedback or a reward for the animal. In some embodiments, the reward device may be part of the system, or it may be external to the system.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like refer to the action and processes of a computer system, or similar electronic computing device, that manipulates and transforms data represented as physical (electronic) quantities within the computer system memories or registers or other such information storage, transmission, or display devices.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

Following is a description of the 1) the components of the systems including: A) exemplary hardware and B) exemplary machine learning models, followed by 2) exemplary methods of autonomously training an animal, in accordance with some embodiments herein.

### I. Exemplary Hardware and Machine Learning Architecture

Aspects described herein relate to a system for autonomously training and providing mental enrichment, entertainment, and/or exercise to animals (e.g., canines, and/or other species of animals). A description of various hardware components is first provided, followed by a description of various machine learning models that can be used in conjunction with the various hardware components to autonomously train an animal.

### A. Exemplary Hardware

The system may include one or more devices that are communicatively coupled and/or interconnected with each other or at least a subset of the hardware components and/or devices. One or more of the devices of the system may be input devices configured to provide an input to the system. Examples of the one or more hardware components and/or input devices may include but are not limited to a wearable device 102 and/or a satellite unit 112. In some embodiments, the system may be configured to communicate with and/or include a reward device configured to dispense a reward. A reward device may be, for example, dispenser 123 and/or other similar components and/or devices. The one or more hardware components and/or devices of the system can have a modular design such that they can be retrofitted to various existing animal products, devices, and systems. For example, wearable device 102 may be retrofitted to an existing collar worn by the animal.

Further, the one or more hardware components and/or devices of the system may be configured to communicate via a network connection. Although the various components of the system may be in wireless communication with one another and configured to interact with one another, in some embodiments, the components of the system may be configured to individually perform any of the functions described herein. For example, if a user and their animal were to travel away from their home system comprising satellite unit 112 and dispenser 123, the wearable device 102 can be configured to collect data on the behavior of the animal, implement one or more training plans, and provide feedback to the animal while outside of a range of connectivity of the satellite unit 112 and/or dispenser 123.

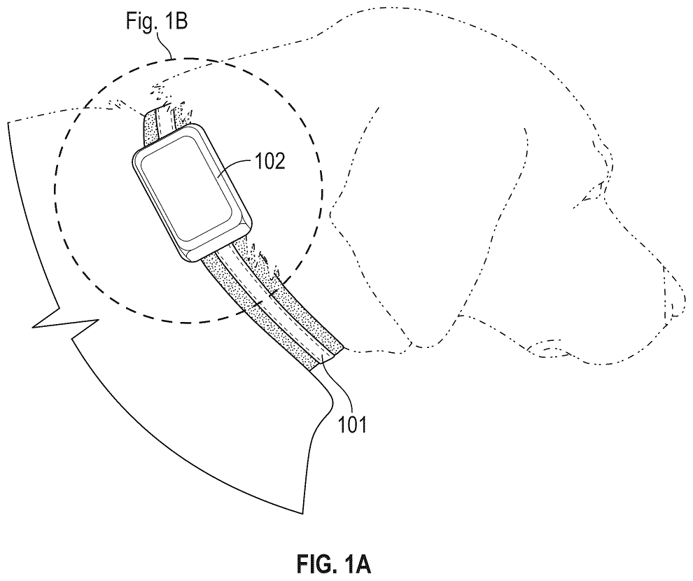

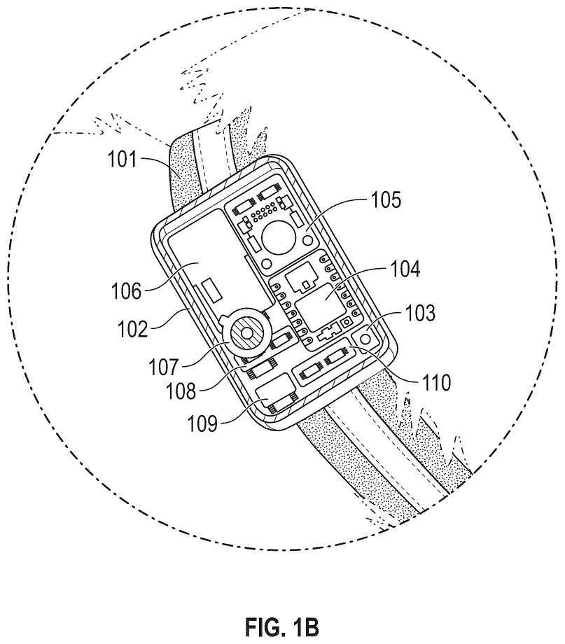

FIG. 1A illustrates an animal wearing a wearable device, in accordance with some embodiments. A wearable device 102 may be connected to, coupled to, part of, and/or housed in a wearable component 101 (e.g., a collar, and the like), which may be configured to be worn by an animal (e.g., a dog, and the like). In some embodiments, the wearable device 102 may encompass wearable component 101 in that the wearable device 102 may be a wearable component on its own, such as a collar, harness, or the like. In other embodiments, wearable device 102 may be a modular device, as shown in FIG. 1A, that can be attached to an existing collar or other wearable component 101. The wearable device 102 may be configured to relay one or more inputs from the animal to the system, and/or may be configured to relay one or more outputs from the system to the animal. In some embodiments, the wearable device 102 may comprise a metal enclosure containing a lithium-ion battery, one or more processors, memory, a storage device, various sensors, and/or a microcontroller.

FIG. 1B shows an exploded view of wearable device 102, in accordance with some embodiments. In some embodiments, the wearable device 102 may be configured with one or more microphones 103, one or more motion sensors 105 (e.g., an attitude and heading reference system (AHRS), 9-axis inertial measurement unit (IMU) with accelerometer, gyroscope, magnetometer, and the like), a battery 106 (e.g., lithium-ion battery, disposable battery, and the like), a speaker 107, a heart rate sensor 108, a temperature sensor 109 (e.g. an infrared (IR) temperature sensor, a thermocouple or resistance temperature detector (RTD)), a global positioning system (GPS) receiver 110, and other such sensors and/or similar components and/or devices. In some embodiments, the wearable device may be configured to provide the data from the various sensors as an input to the system. In some embodiments, the wearable device 102, may be configured with one or more processors 104 (e.g., microcontroller, and the like). In some embodiments, the wearable device 102 may include a camera (not shown). In some embodiments, the camera may include a complementary metal-oxide semiconductor (CMOS) sensor or a charge-coupled device (CCD) sensor.

In some embodiments, the wearable device 102 may be programmed with computer code to perform the various functions described herein without the use of a machine learning model. Alternatively, in some embodiments, wearable device 102 may utilize one or more machine learning models to perform the various functions described herein. In some embodiments, data collected by the sensors in the wearable device 102 can be labeled and can be used to train one or more machine learning models to determine a behavior of an animal from the sensor data, as will be described.

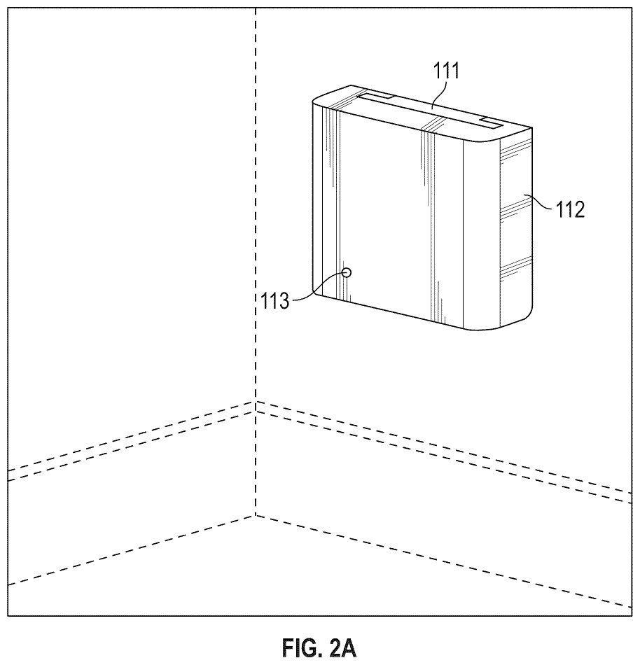

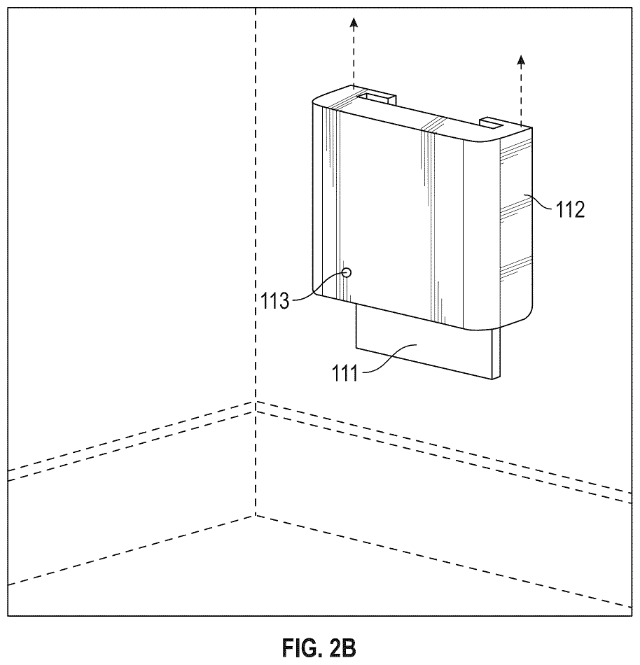

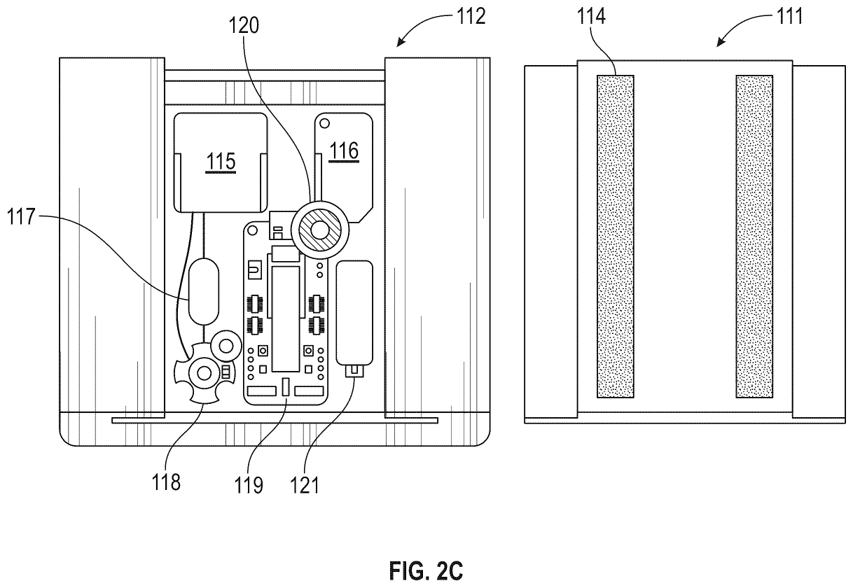

In some embodiments, as shown in FIG. 2A, a satellite unit 112 may be configured to be attached to a wall or other surface (e.g., via a mounting bracket 111 as shown in FIG. 2A). The satellite unit 112 may be configured to relay one or more inputs from the wearable device 102 to the system, and/or may be configured to relay one or more outputs from the system to the wearable device 102. In some embodiments, the satellite unit 112 may be configured with a camera 115, a distance sensor 116 (e.g., a time-of-flight distance sensor, a LiDAR sensor, and the like), a vibration sensor 117, one or more light emitting diodes (LEDs) 118 (e.g., blue LEDs, yellow LEDs, and the like), one or more speakers 120, one or more microphones 121, and the like, as shown in FIG. 2C. In some embodiments, satellite unit 112 may be configured to provide the data from the various sensors as an input to the system.

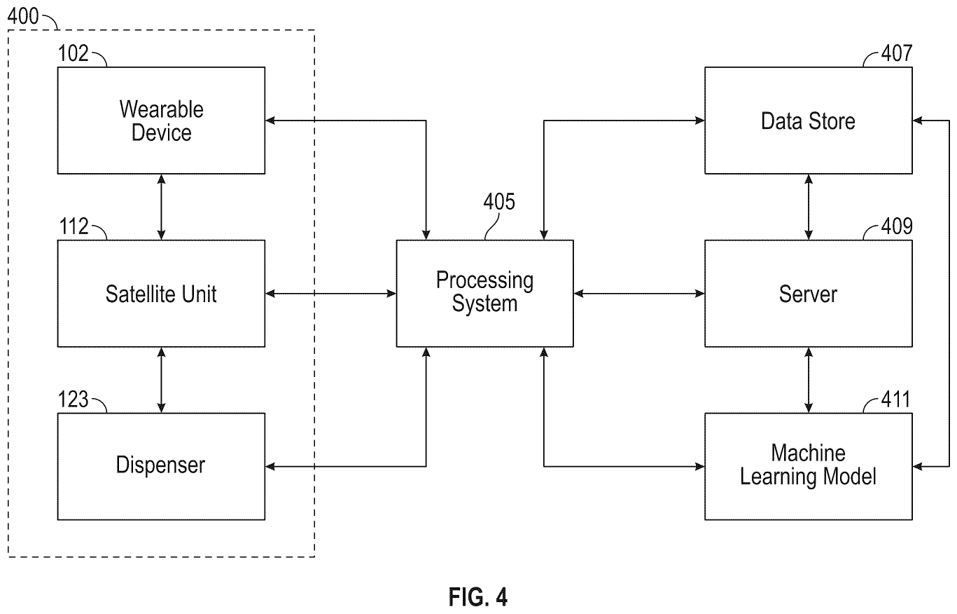

In some embodiments, the satellite unit 112 may be configured with one or more processors 119 (e.g., microcontroller, and the like), as shown in FIG. 2C. In some embodiments, satellite unit 112 may be configured to communicate with an external processing system (e.g. FIG. 4, 405). In some embodiments, the satellite unit 112 may comprise a view hole 113 for distance sensor 116. In some embodiments, the satellite unit 112 may be configured with a battery (e.g., lithium-ion battery), which is not shown separately. In some embodiments, the mounting bracket 111 may include one or more attaching, connecting, and/or fastening mechanisms (e.g., adhesive strips, hook and loop strips, and the like), as shown in FIG. 2C. In some embodiments, satellite unit 112 may be installed in an indoor environment, such as a user's home, or an outdoor environment, such as a user's yard. In some embodiments, satellite unit 112 may include one or more of the same components as described with respect to wearable device 102 and/or dispenser 123, and wearable device 102 and/or dispenser 123 may include one or more of the same components as satellite unit 112.

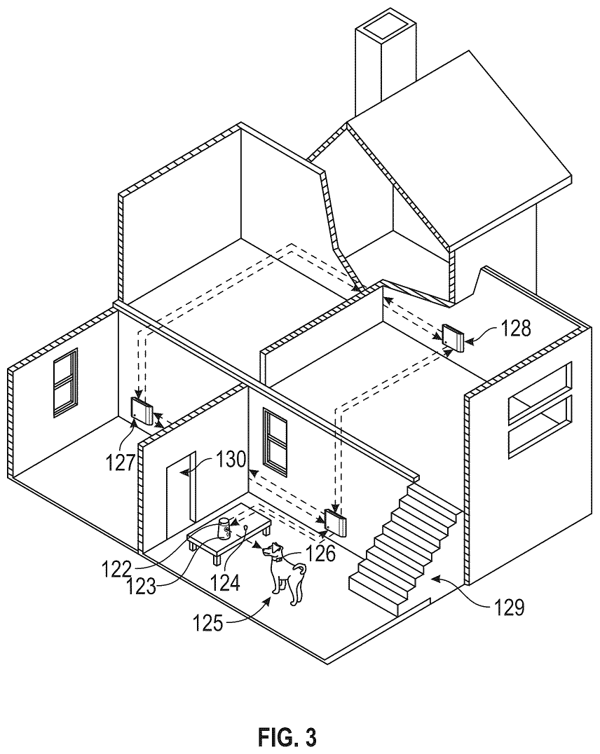

FIG. 3 illustrates an arrangement of a system for autonomously training an animal, according to some embodiments. In some embodiments, the system may comprise a reward device such as dispenser 123. In some embodiments, the reward device such as dispenser 123 is external to the system, but the system is configured to communicate with the dispenser 123. The dispenser 123 may be configured to relay one or more outputs from the system to the wearable device 102 on the animal 125. The dispenser 123 may be configured to provide one or more reinforcers 124 (e.g., food reinforcers, toys reinforcers, instructions, sounds, and the like) to the animal 125. In some embodiments, the dispenser 123 may be configured to provide one or more secondary reinforcers that may cause the animal to anticipate a delivery of one or more primary reinforcers. For example, primary reinforcers are inherently reinforcing to the animal, i.e. food. Audible feedback such as praise may be a secondary reinforcer because its value comes from the primary reinforcer that their appearance predicts, i.e. the secondary reinforcer has no value to the animal until it is first paired with the primary reinforcer.

In some embodiments, the reinforcer is a durable object coupled to the dispenser, such as a rope or other toy, which can provide mechanical resistance to pulling by the animal to provide positive reinforcement to the animal through engagements. In some embodiments, the dispenser 123 may be configured with one or more components 122 (e.g., one or more cameras, one or more microphones (e.g., one or more omnidirectional microphones), one or more speakers (e.g., a speaker array), and the like). The dispenser 123 may be configured with memory (not shown separately), and one or more processors (not shown separately) coupled to the memory.

The system may include a wearable device 126, which may be similarly configured as wearable device 102, and which is worn by the animal 125. The system, as shown in FIG. 3, may include multiple satellite units 127, 128. The satellite units 127, 128 may be similarly configured as satellite unit 112. The system, as shown in FIG. 3, may be located in an environment (e.g., a house, a building, and the like) with multiple levels connected via a staircase 129 and may include multiple rooms connected via a doorway 130.

In some embodiments, the system may connect to a processing system (e.g., the cloud computing device) via the Internet and/or other wired or wireless communication protocols, and the system may be configured to select and retrieve and/or obtain a training program. In some embodiments, the system may be configured to perform its functions without Internet connectivity and can receive updates on a USB storage device that may have been programmed by a computing device with Internet connectivity. In some embodiments, one or more components of the system may be connected to a mesh or a non-mesh network topology. In some embodiments, dispenser 123 and satellite units 127, 128 directly connect to WiFi at a home, training facility, etc. This connection can be used to communicate with a processing system such as a Cloud Controller backend, i.e. Google Cloud, as well as on local development platforms, such as a laptop on the same WiFi network. In some embodiments, a laptop, computer, or other computing device/mobile device may serve as a controller rather using a Cloud Controller.

In a non-mesh topology, the range of dispenser 123 and satellite units 127, 128 is limited by the coverage of the WiFi network. Additionally, the wearable device 126 may connect via Bluetooth to dispenser 123, satellite units 127, 128, and/or a processing system. Any of the wearable device 126, satellite units 127, 128 and/or dispenser 123 can relay communications with each other and with a processing system. In a mesh topology, dispenser 123 and/or satellite units 127, 128 can function as mesh network nodes. At least one of dispenser 123 and/or satellite units 127, 128 can be in WiFi range. Other dispensers 123, satellite units 127, 128, and/or the wearable device 126 can connect either directly to WiFi or can connect to a nearby dispenser or satellite via standard mesh networking protocols over WiFi and/or Bluetooth.

For example, in a residential setting, dispenser 123 might be placed on the user's back porch, where it can connect to WiFi based inside the house. The satellite units 127, 128 might be placed out in the user's yard, where they are out of WiFi range. By using a mesh network topology, the satellite units 127, 128 can discover each other and the feeder, form a mesh network, and then be addressable by the processing system over this mesh network.

For example, in an outdoor agility competition setting, dispenser 123 might be placed at the judge's table, where it may be connected to WiFi. The satellite units 127, 128 might be placed along the agility course, where some of them are out of WiFi range. By using a mesh network topology, the satellite units 127, 128 can discover each other and the feeder, form a mesh network, and then be addressable by the controller over this mesh network.

In some embodiments, the system may include one or more processing systems configured to communicatively couple and/or connect to various types of modular devices, such as one or more wearable devices 102, one or more satellite units 112, one or more dispensers 123, and/or components of such modular devices. In some embodiments, the system may be configured to communicate with an external processing system comprising a controller that is configured to communicatively couple and/or connect to various types of modular devices. In some embodiments, the controller may be a software module. In some embodiments, an instance of the controller may be executed and/or hosted on one or more of the modular devices (e.g., dispenser(s) 123, satellite unit(s) 112, wearable device(s) 102, and the like) of the system. In some embodiments, the one or more processors of dispenser(s) 123, satellite unit(s) 112, and the wearable device(s) 102 described with respect to FIGS. 1A-3 above may have any of the same capabilities as the “processing systems” described herein, and the processing systems described herein may have the same capabilities as the one or more processors.

In some embodiments, the one or more processing systems (e.g., via execution of the controller) of the system may provide one or more application programming interfaces (APIs) that are configured to allow one or more modular devices, including third-party modules and/or third-party modular devices (e.g., modular devices that were not originally part of the system), to connect to the system. In some embodiments, satellite unit 112, wearable device 102, and/or dispenser 123 may include a built-in visual display or touch screen configured to display outputs of the system to a human user monitoring the system. In some embodiments, satellite unit 112, wearable device 102, and/or dispenser 123 can communicate with an external computing device, which may similarly have a built-in visual display or touch screen configured to display outputs of the system to a human user monitoring the system.

The system may be configured and/or designed to operate across multiple rooms and floors and in any type of building, including, but not limited to, a training facility, a boarding facility, a healthcare facility for animals or humans, a crime scene, a military installation, a film set, a stadium, a theater, a motor vehicle, a marine vessel, an aircraft, a spacecraft, and/or other indoor environments. The system may also be configured and/or designed to operate in outdoor environments including, but not limited to, residential yards, parks, farms, ranches, zoos, military theaters, areas contaminated with unexploded ordnance or landmines, on bodies of water, underwater, tunnels, caves, and the like.

In some embodiments, the wearable device 102 and/or the satellite units 112 may be configured and/or designed to be waterproofed, resistant to shock and/or vibration, withstand extreme temperatures, and/or protected from other environmental elements and/or factors. In some embodiments, the dispenser 123 may be equipped with a mounting bracket that allows it to be placed away from environmental elements and/or factors. The dispenser 123 may be configured and/or designed to withstand extreme temperatures.

The system may be configured to selectively trigger provisioning of a configurable amount, and/or for a configurable duration of time, of reinforcer from a network-attached reward device, such as a dispenser 123. The network-attached reward device, such as a dispenser 123, may be configured to provide one or more reinforcers that are desirable to the animal. Examples of providing the one or more reinforcers may include, but are not limited to, physical ejection of a food reinforcer, triggering of the animal's chase behavior by launching an object, triggering of the animal's grab-bite and kill-bite behaviors by providing a durable object attached to a surface by a cable that can be pulled by the animal and that can provide mechanical resistance to the animal's pulling, or triggering (e.g., intentionally triggering) any other element of the animal's predatory motor pattern that the animal finds positively reinforcing. In some embodiments, the system may be configured to trigger (e.g., intentionally trigger) any other element of the animal's predatory motor pattern either by directly or indirectly triggering a prior element in the animal's predatory motor pattern and allowing the animal to naturally progress into the desired element of its predatory motor pattern including via intermediate elements of the predatory motor pattern.

The system may be configured to provide mental enrichment, entertainment, and/or physical activity for the dog by emitting one or more sequences of audio and/or visual cues that are previously trained by the system into the animal. The system may reward the animal for providing desired inputs to the system. Examples of desired inputs to the system may include, but are not limited to, performance of one or more requested behaviors, physical activation of one or more requested sensors of various types across large distances, and the like.

The system may be configured to allow for the feeding of the animal's full daily diet and/or maintenance of the animal's target weight by providing food reinforcers. In some embodiments, the system may be configured to provide food reinforcers when the animal provides a requested input to the system, and/or by automatically calibrating the level of training and/or activity provided to the animal based on the animal's caloric needs. In some embodiments, the system may be configured to receive the animal's caloric needs as an input by a human. In some embodiments, the system may be configured to retrieve or obtain the animal's caloric needs from an internal or external database of animal caloric needs. In some embodiments, the system may be configured to determine the animal's caloric needs based on the animal's previously provided calorie related inputs to the system. The system may be configured to automatically calibrate the quantity of food provided during each reinforcement cycle based on animal's caloric needs and/or the total expected duration of interaction with the system.

In some embodiments, the system may be configured to receive data from the wearable device 102, the satellite unit 112, and/or the dispenser 123 via a processing system and can integrate with an existing smart home system. The system may be configured to identify, based on the data from the wearable device 102, the satellite unit 112, and/or the dispenser 123, a behavior of the animal using a machine learning model. The system may be configured to cause the dispenser 123 to release a reinforcer for the animal based on the behavior or provide one or more instructions to the animal to perform one or more additional behaviors. The system may be configured to transmit a notification or a control message to the smart home system based on the behavior or status of the animal. The system may be configured to receive a notification or control message from the smart home system and adjust the behavior of the animal or the system based on the received message.

In some embodiments, the smart home system may comprise one or more devices for monitoring or controlling the environment, feeding schedule, or health of the animal, and the system (e.g., via one or more processors, the controller, and the like) may be configured to integrate with the smart home system to provide an integrated and automated solution for animal care. In some embodiments, the system (e.g., via one or more processors, the controller, and the like) may be further configured to receive data from the smart home system, such as temperature, humidity, or lighting conditions, and adjust the training plan or reinforcer based on the environmental conditions. In some embodiments, the system (e.g., via one or more processors, the controller, and the like) may be further configured to receive data from a camera or other monitoring device in the smart home system and adjust the training plan or initiate a comforting resolution based on the animal's behavior or response to the environment.

In some embodiments, the system may be configured to integrate with a smart home system for monitoring and controlling the environment, feeding schedule, or health of the animal, and/or adjusting the training plan or providing a comforting resolution based on the data from the smart home system. In some embodiments, the system may be configured to receive a notification or control message from the smart home system and adjusting the behavior of the animal or the system based on the received message.

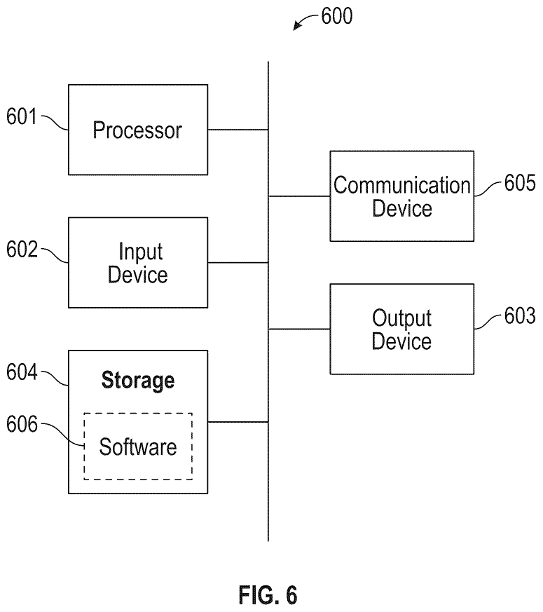

FIG. 6 depicts the parts of a computer, in accordance with various embodiments. As will be appreciated, processing system 405, which will be described with respect to FIG. 4 can include one or more of the components as will be described with respect to computer 600. Computer 600 can be a component of a data collection system for configuring the system for autonomous training and enrichment of animals and for viewing the collected data.

Computer 600 can be a host computer connected to a network. Computer 600 can be a client computer or a server. As shown in FIG. 6, computer 600 can be any suitable type of microprocessor-based device, such as a personal computer, workstation, server, videogame console, or handheld computing device, such as a phone or tablet. The computer can include, for example, one or more of processor 601, computer input device 602, output device 603, storage 604, and communication device 605. Computer input device 602 can generally correspond to those described above and can either be connectable or integrated with the computer.

Computer input device 602 can be any suitable device that provides input, such as a touch screen or monitor, keyboard, mouse, or voice-recognition device. Output device 603 can be any suitable device that provides output, such as a touch screen, monitor, printer, disk drive, or speaker.

Storage 604 can be any suitable device that provides storage, such as an electrical, magnetic, or optical memory, including a RAM, cache, hard drive, CD-ROM drive, tape drive, removable storage disk, or other non-transitory computer readable medium. Storage 604 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 605 can include any suitable device capable of transmitting and receiving signals over a network, such as a network interface chip or card. The components of the computer can be connected in any suitable manner, such as via a physical bus or wirelessly. Storage 604 can be a non-transitory computer-readable storage medium comprising one or more programs, which, when executed by one or more processors, such as processor 601, cause the one or more processors to execute methods described herein.

Software 606, which can be stored in storage 604 and executed by processor 601, can include, for example, the programming that embodies the functionality of the present disclosure (e.g., as embodied in the systems, computers, servers, and/or devices as described above). In some embodiments, software 606 can be implemented and executed on a combination of servers such as application servers and database servers.

Software 606, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 604, that can contain or store programming for use by or in connection with an instruction execution system, apparatus, or device.

Software 606 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, Tl or T3 lines, cable networks, DSL, or telephone lines.

Computer 600 can implement any operating system suitable for operating the network. Software 606 can be written in any suitable programming language, such as C, C++, Java, or Python. In various embodiments, application software embodying the functionality of the present disclosure can be deployed in different configurations, such as in a client/server arrangement or through a web browser as a Web-based application or Web service, for example.

### B. Exemplary Machine Learning Models

The system may implement and/or be configured with scientifically sound positive reinforcement training, in which desired behaviors in an animal may be induced to occur more frequently by the provision of reinforcers such as food, which is a primary reinforcer. The system may autonomously train animals to respond to audio and/or visual cues emitted by the system, emitted by a human both with and without the presence of the system, emitted by other animals, or emitted from the animal's environment, such as by the sun during sunrise or sunset. These functions may be implemented by determining the animal's behavior in real time through the use of a trained neural network that processes real-time or near real-time motion sensor data, audio data, video data, global positioning system (GPS) location data, and/or other sensor data transmitted by a wearable device 102, a satellite unit 112, and/or other sensors.

In some embodiments, the system may be programmed to autonomously train an animal through computer code, which may not employ artificial intelligence or machine learning models. For example, to detect a dog performing a “spin,” the system may be programmed with code that accepts angular rotation data from an IMU as an input. The code may be programmed with a predefined direction of spin, a time window for a dog to perform the spin, and various integer points of angular rotations leading up to a complete spin. The code may be programmed to cause the system to dispense a reward each time these integer points are detected in the data, and by repeating this process for increasing integer points of a spin, a dog can be incrementally trained to perform a complete spin.

In some embodiments, the system may be programmed to autonomously train an animal through one or more machine learning models. In some embodiments, an animal may be trained through a combination of machine-learning based methods and code-based methods. The following section describes exemplary machine learning models that can be used in some embodiments.

The exemplary machine learning models described herein may utilize one or more object detection algorithms to detect a behavior in an animal. The machine learning models may utilize R-CNN, Fast R-CNN, Faster R-CNN, YOLO, and other object detection algorithms. The machine learning models may also utilize an audio classifier algorithm, such as R-CNN, Fast R-CNN, Mask R-CNN, or other audio classifier algorithms. In some embodiments, the one or more machine learning models may be provided and configured by an Arduino machine learning toolchain.

FIG. 4 illustrates components of an exemplary system 400 for autonomously training an animal, in accordance with some embodiments. As mentioned, an exemplary system 400 includes an input device, which may be at least one of a wearable device 102 or a satellite unit 112. Optionally, system 400 may include a dispenser 123. Wearable device 102, satellite unit 112, and/or dispenser 123 may include an attitude and heading reference system (AHRS) and a 9-axis inertial measurement unit (IMU). An advantage of using an AHRS is that the location of an animal can be tracked continuously and over a broad range, such as over an entire house or training facility as well as outdoors. This allows for an animal's training program to be configured based on both their learned behaviors as well as their unlearned, natural activities. The AHRS can be configured to perform sensor fusion on data collected by the IMU, for example, by using a Kalman filter.

Wearable device 102, satellite unit 112, and/or dispenser 123 may also include a time-of-flight sensor such as a LiDAR sensor, which may be used to precisely determine the distance from the animal to the sensor. Wearable device 102, satellite unit 112, and/or dispenser 123 may include a location sensor such as a global positioning system (GPS) receiver. Wearable device 102, satellite unit 112, and/or dispenser 123 may also include a camera and microphone.

Wearable device 102, satellite unit 112, and/or dispenser 123 may be configured to communicate with a processing system 405. In some embodiments, processing system 405 may not be part of system 400. For example, in some embodiments, wearable device 102, satellite unit 112, and/or dispenser 123 may be configured to communicate with processing system 405, which may be an external computing system. In other embodiments, processing system 405 may be part of the wearable device 102 and/or satellite unit 112 as one or more processors, etc.

The data collected from the sensors may include IMU data, which can include accelerometer, gyroscope, and magnetometer data. The accelerometer, gyroscope, and magnetometer data can include a roll, pitch, yaw, linear acceleration, angular velocity, and magnetic field information. The data may further include sample point clouds, sample position data including X/Y/Z coordinates and location data, sample sound data, and sample image/video data.

The AHRS may perform sensor fusion on the accelerometer, gyroscope, and magnetometer data to integrate the data into a simplified form that can be inputted into a machine learning model. The data can be transmitted from the AHRS to the processing system 405, inputted into a machine learning model 411, and the model can be trained from the data.

Alternatively, there may be a data store 407 and/or a server 409, which can store pre-existing datasets that can be used to train machine learning models. In some embodiments, data store 407 and/or server 409 may be part of the processing system 405, or they may be external to the processing system. The processing system 405 may be configured to access data store 407 and/or server 409 to retrieve training data, which can then be inputted into machine learning model 411. Machine learning model 411 may be configured to access data store 407 and/or server 409 and retrieve training data directly, and machine learning model 411 may also be configured to write one or more outputs from the model indicating determined behaviors, outcomes of training sessions, etc., to data store 407 and/or server 409.

In some embodiments, the machine learning models are trained from a pre-existing dataset. The dataset may include pre-labeled training samples. The dataset may be a publicly available dataset of various animals observed performing various behaviors with and without reinforcement. The training samples can include IMU data, which can include accelerometer, gyroscope, and magnetometer data. The accelerometer, gyroscope, and magnetometer data can include a roll, pitch, yaw, linear acceleration, angular velocity, and magnetic field information. The training samples may include sample point clouds, sample position data including X/Y/Z coordinates and location data, sample sound data, and sample image/video data. These training samples may be obtained from various species, breeds, and sizes of animals. The samples may reflect various behaviors, stages of behaviors, and movement patterns performed by various animals, and may include point cloud and camera images of animals performing these behaviors, stages of behaviors, and movement patterns, as well as sounds made by the animals in the sample set. The training data may include audio data, such as animal noises, traffic noises, city noises, etc. The training data may be stored in a data store 407 or a server 409 of the system, where it may be accessed by the controller of the processing system or the machine learning model.

In other embodiments, the system can be used to annotate the data collected by the sensors so that the data can be used as training data for machine learning models. For example, in addition to the AHRS described above, wearable device 102, dispenser 123, and/or satellite unit 112 may include one or more cameras and microphones, which may capture videos and sounds of an animal performing various behaviors both from the point of view of the animal and from the point of view of the satellite unit 112 observing the animal. Meanwhile, the wearable device 102 and/or satellite unit 112 can simultaneously collect accelerometer, gyroscope, and magnetometer data comprising a roll, pitch, yaw, linear acceleration, angular velocity, as well as sample point clouds from the time-of-flight sensor, sample position data including X/Y/Z coordinates and location data. Sensor fusion may be performed by the AHRS, and the fused data can be sent to the controller 405 to be stored or used as an input for a machine learning model. In some embodiments, one or more machine learning models may be trained from fused data from the AHRS, and in some embodiments, one or more machine learning models may be trained from raw sensor data.

Because the data can be collected from the various sensors while simultaneously recording a video of the behavior using a camera, the sample position data, point clouds, etc. can be manually labeled to indicate various information associated with a particular behavior, motion pattern, etc. The sensor data can be labeled by matching up the timestamps of both the captured videos of the behavior and the data collected by the other sensors to label the sensor data at the appropriate frames. The labeled data may indicate a position of the animal, such as X, Y, and/or Z coordinates, an orientation of the animal, the detected behavior of the animal, such as the animal's facial expression, the animal's velocity, and/or the animal's direction of travel. The labeled data can then be used to train one or more machine learning models to detect the performance of a threshold portion of a behavior, a movement pattern associated with the behavior, a pose associated with the behavior, and so on.

Additionally, the machine learning models can be trained from the collected data through monitoring successful and failed performances of a behavior by an animal. For example, one or more machine learning models may be evaluated by conducting training sessions on different sample populations of animals and collecting data on successful and failed attempts of each animal in each sample population in performing the desired behavior. The collected data can be used to train one or more machine learning models to recognize various successful and failed attempts at performing a specific behavior as well as to improve the autonomous training capability of the system. In some embodiments, the data regarding the successful and failed attempts at performing the specific behavior may be stored or displayed by processing system 405.

In some embodiments, a machine learning model can be trained to detect a behavior that is specific to an individual animal, and in other embodiments, a machine learning model can be trained to detect a behavior from data associated with a sample of many different sizes, types, and/or breeds of animals. For example, a dog may bark in response to a car going by. In some embodiments, sound data associated with the dog's bark over a period of time may be captured by the one or more microphones in wearable device 102, satellite unit 112, and/or dispenser 123. In some embodiments, the sound data may be captured continuously, but it may only be saved and stored by the system if a bark is detected.

The sound data may be used to train a machine learning model either to detect the sound of a dog barking globally or to detect the specific dog's bark in response to a specific stimulus. For example, a machine learning model can be trained using training data comprising sound data samples of the specific dog's bark along with sound data of other dogs' barks so that the machine learning model can be trained to detect the sound of a bark globally. Additionally, presuming the dog barks in response to a car going by, the sound data captured of the dog barking may also include sound data contributed by the passing car. Thus, the “global” bark machine learning model can be used to detect the presence of a bark sound in the data, and a second machine learning model can be trained from the sound data to associate the dog barking with the sound of the car. This can allow for a machine learning model to be trained that is specific to a particular animal, so that the model to can be used identify or generate one or more training plans that can address the specific animal's behavior.

In some embodiments, the system may collect sound data and train one or more machine learning models based on the collected data using an Arduino Nicla Voice board or an ESP-32 board, such as an ESP32-S3 or ESP32-C3. However, the system may be outfitted with any other suitable sound, speech, and/or voice recognition hardware having artificial intelligence/machine learning compatibility. Additionally, data labeled in this manner can be stored in data store 407 and/or server 409 for re-training and refining machine learning models so that they are more accurate and customizable to suit the particular needs of the animal or its human trainer.

In some embodiments, machine learning model 411 may be a large language model (LLM) trained on a corpus of published behavior science knowledge and animal training knowledge. For example, the LLM may be trained from textbooks, published articles, transcripts and videos of lectures relating to animal behavior science or behavior science generally, and so on. The LLM may be trained to receive speech or freeform natural-language text input from the microphones of the system or from a user interface of the wearable device 102 or satellite unit 112. The user or other parties with access to an animal's profile may provide speech or text input indicating an assessment of an animal's performance during a training session. The LLM may be trained to analyze the speech assessment of the animal's performance, output a response comprising natural language, and select an appropriate training plan or task based on the speech input. For example, a user input may tell the LLM via a chatbot app interface that their animal keeps jumping on the counters, and the chatbot might reply “I'm sorry to hear that, let's set the animal up with some training to try to address that problem” while prioritizing an anti-jumping training plan. Methods of training an animal in accordance with training plans that are selected based on behaviors autonomously detected by one or more of the machine learning models described herein will be further described in the following section.

### II. Exemplary Methods of Autonomously Training an Animal

In some embodiments, the system may use one or more machine learning models to implement a behavioral shaping method to train an animal. In some embodiments, the system may be configured with one or more machine learning models each associated with and trained to recognize a particular behavior or trick, such as “sit” or “paw.” In some embodiments, for more complex behaviors, the system may be configured with one or more machine learning models each associated with and trained to recognize a stage, or threshold portion of a behavior, the behavior being associated with a predetermined motion pattern. For example, if the behavior to be trained is “down,” the system may be configured with a first machine learning model trained to detect a “sit” threshold portion of the “down” predetermined motion pattern, with the animal's hind legs on the ground. A second machine learning model may be trained to detect when a first front leg of the animal touches the floor, and a third machine learning model may be trained to detect when both front legs of the animal touch the floor. The predetermined motion pattern associated with the “down” behavior would be the complete motion pattern of the animal through all of the threshold portions strung together, i.e. the motion pattern of the animal putting each back paw down, then each front paw down, or vice versa.

In some embodiments, the system may be configured to acclimate the animal to the system's presence by gradually or slowly introducing sounds, such as audio reproductions of mechanical sounds normally made by modules of the system, and the like, at lower volumes and in shortened segments initially, and increasing those volumes and/or segment lengths over time. In some embodiments, the system may start by liberally or freely provisioning food or the opportunity to engage in preferred activities without requiring the animal to perform any specific behavior in order to earn rewards. The system may be configured to refine the criteria (e.g., criteria for providing food, and/or other preferred rewards or reinforcers associated with the animal) over time based on one or more inputs associated with the animal. For example, the system may be configured to cause a reward device to dispense a reward for the animal when a location of the animal is determined to be within a specified range of the system to encourage the animal to interact with the system.

The system may be configured to cause the reward device to dispense a reward upon a determination by the system that the animal is within a distance threshold of the satellite unit and/or dispenser. In some embodiments, a distance threshold may be greater than or equal to 1, 2, 3, 4, 5, 6, 7, 8, or 9 meters. In some embodiments, a distance threshold may be less than or equal to 2, 3, 4, 5, 6, 7, 8, 9, or 10 meters. In some embodiments, the system may be configured to adjust or gradually decrease the distance threshold for dispensing the reward so that the animal is incrementally trained and rewarded for being in close proximity to one or more components of the system.

In some embodiments, the system may be configured to adjust the distance threshold based on a detected comfort level of the animal. For example, the system may be configured to increase the distance threshold (such that the animal does not have to come very close for a reward to be dispensed) if the wearable device 102 detects an abnormally high heart rate of the animal or detects various audible cries or barks from the animal. In some embodiments, the system may assign a numerical score for the comfort level of the animal based on heart rate data, a certain number of cries within a certain time period, or based on other physiological characteristics of the animal observed by the system. In some embodiments, the user may be prompted to follow one or more manual steps, which may be indicated and/or displayed on a visual display or touch screen of the satellite unit 112, the wearable device 102, and/or the dispenser 123 in some embodiments. In some embodiments, one or more prompts to the user may be displayed in an application executable on an external computing device (e.g., processing system 405, a mobile computing device, and the like), to aid the animal in acclimating to the system.

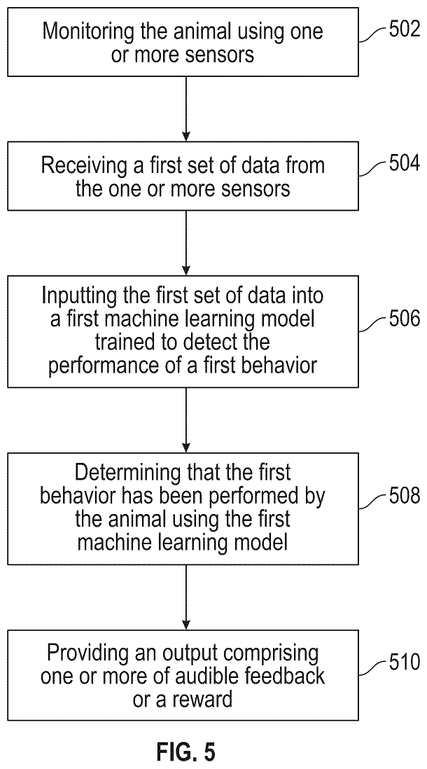

FIG. 5 illustrates a method 500 for autonomously training an animal, according to some embodiments. In some embodiments, method 500 may be implemented by the system once the system determines that the animal has reached a certain comfort level with the system. At block 502, during a training session, a method may include monitoring the animal using one or more sensors. At block 504, the method may include receiving a first set of data from the one or more sensors 504. The processing system 405, for example, may be configured to receive a first set of data from the input device(s) such as wearable device 102 and/or the satellite unit 112. The first set of data may correspond to a first behavior or stage of behavior that is to be performed during a training session. As described, the sensors may include a microphone, a camera, a gyroscope, an accelerometer, a magnetometer, an inertial measurement unit (IMU), and/or a global positioning system (GPS). In some embodiments, the system may include an attitude and heading reference system (AHRS). The first set of data can include a pose, a linear acceleration, an angular velocity, a location, a sound, an image, and/or magnetic field information, as described above.

At block 506, the first set of data can be combined using sensor fusion and can be inputted by the processing system into a machine learning model. For example, the AHRS may detect a starting pose of an animal, the pose including a position and orientation of the animal using the data collected by the IMU, etc. The processing system may be configured to track changes to the animal's pose over a determined period of time, and this data may be inputted into a machine learning model associated with a desired behavior. The machine learning model can be trained to detect the performance of a first behavior in the raw sensor data or in fused data after the AHRS performs sensor fusion on the raw sensor data. For example, the machine learning model may be trained from training data comprising one or more of an animal pose, an animal linear acceleration, an animal angular velocity, an animal location, an animal sound, an animal image, and/or animal magnetic field information.

At block 508, the machine learning model, having been trained to associate particular sensor data (motion data, position data, etc.) with the performance of a desired behavior, can thus determine whether the first behavior has been performed from the collected sensor data. Upon determining that the first behavior has been performed by the animal using the first machine learning model, the machine learning model may provide an output to the processing system, via a signal, for example, indicating that the machine learning model has determined that the first behavior has been performed. In some embodiments, the determination by the machine learning model at block 508 can be stored as data, and the system may use the data to evaluate the training progress of the animal or develop one or more custom training plans for the animal. At block 510, the system may provide an output comprising one or more of audible feedback, e.g. a command or praise, or a reward, e.g. a food reward or a toy.

For example, the machine learning model can signal the processing system indicating that the desired behavior has been performed, and the processing system can then instruct the dispenser 123 to provide the animal with a reward. For example, the reward may include a treat, a toy, or audible feedback including praise for the animal and/or a positively reinforcing noise for the animal, such as a “click.” In some embodiments, the audible feedback may further include a verbal command associated with the behavior such that the animal is trained to associate the verbal command with the behavior. In some embodiments, the audible feedback may further include additional verbal instructions to the animal to perform one or more additional behaviors. In some embodiments, the audible feedback may further include a correction for the animal.

As mentioned above, in some embodiments, one machine learning model may be trained to detect one particular behavior or stage of behavior. Thus, in some embodiments, the data from the various sensors can be inputted by the processing system into a second machine learning model trained to detect a second behavior or a second stage of behavior. For example, if the output includes instructions to the animal to perform one or more additional behaviors, a second machine learning model associated with the one or more additional behaviors can be used to identify the performance of the one or more additional behaviors.

In some embodiments, a machine learning model can be trained to associate the successful completion of a desired behavior with a predetermined motion pattern and can be trained to define threshold portions of the predetermined motion pattern that can be adjusted based on an animal's successful and/or failed attempts at completing the predetermined motion pattern. The motion pattern is “predetermined” from the training data that was used to train the machine learning model prior to implementation into the system. For example, the predetermined motion pattern may be a full “spin,” or a three-hundred sixty degree clockwise or counterclockwise rotation depending on the behaviors captured in the data samples that were used to train the machine learning model, as described above.

To autonomously train an animal to spin, a machine learning model may be trained to set an initial threshold portion of the spin as being a five-degree rotation in one direction in a given period of time, for example, in less than three seconds. During the training session, the system may input fused data from the AHRS into the machine learning model. Based on data regarding the pose, angular rotation, angular velocity, etc. of the animal, the machine learning model can determine whether a threshold portion of the predetermined motion pattern has been satisfied and may output an indication to the system indicating that the threshold portion has been satisfied. In turn, the system may be configured to cause the dispenser 123 to dispense a reward to the animal for completing the threshold portion of the predetermined motion pattern.

Alternatively, the machine learning model can output an indication indicating that the threshold portion has not been satisfied. The machine learning model can be configured to monitor the successes and failures of the animal in satisfying the threshold portion of the predetermined motion pattern and can adjust the threshold portion accordingly. For example, upon successful completion of the five-degree turn described above, the machine learning model may be configured to increase the threshold portion to a ten-degree spin in three seconds. Accordingly, a reward would not be dispensed by the dispenser until the heightened threshold portion, the ten-degree spin, was satisfied. Alternatively, upon a failed attempt at completing the threshold portion, the machine learning model may be configured to decrease the threshold portion, for example, to a three-degree turn, or increase the amount of time provided to the animal to complete the threshold portion. The threshold portion of the predetermined motion pattern can be continuously adjusted until the entirety of the predetermined motion pattern is successfully performed by the animal.

As an additional example, the predetermined motion pattern may be a “stay” behavior characterized by minimal or no movement by the animal. In this example, the initial threshold portion may be set to one meter of motion or less in less than three seconds. The machine learning model can identify a before-and-after position of the animal using the data collected by the sensors and inputted into the machine learning model. Based on the change in position of the animal over the threshold time period, the machine learning model can determine whether the threshold portion has been satisfied. The machine learning model can provide an output indicating a determination that the threshold portion of the “stay” motion pattern has been satisfied or not, and the system can communicate with dispenser 123 to administer a reward accordingly. Then, the machine learning model may be configured to decrease the permitted distance of movement and/or increase the amount of time the animal is required to stay still if the animal satisfies the initial threshold portion.

In some embodiments, examples of a threshold portion of a predetermined motion pattern can include a threshold angular rotation, a threshold distance, a threshold change in velocity, a predetermined gesture, or a predetermined interaction with satellite unit 112. Examples of the threshold angular rotation, distance, and change in velocity (i.e. angular velocity) are described above. An example of a predetermined gesture may be an animal rotating a threshold number of degrees or laying a partial threshold distance down to the ground or floor. An example of a threshold predetermined interaction with satellite unit 112 can include an animal touching the satellite unit 112 with their nose or paw for gradually increasing amounts of time.

In some embodiments, the system may be configured to autonomously create and conduct scheduled training sessions in accordance with a training plan, as opposed to informally training the animal through teaching the animal isolated tricks. For example, the system may receive a first set of data from the wearable device 102, the satellite unit 112 and/or the dispenser 123. The processing system may then input the first set of data into a machine learning model.

In some embodiments, a machine learning model may be configured to implement an initial training plan based on the first set of data, including pose data, sound data from microphones, heart rate data, and other sensors. The machine learning model may use the sensor data to determine the animal's behaviors that are most frequently offered without the provision of reinforcers. These behaviors may be matched or closest matched to a set of training plans that are pre-stored in data store 407 of the system. In some embodiments, wearable device 102, satellite unit 112, and/or dispenser 123 may have one or more touch displays upon which a human user, such as a trainer, may select one or more of the training plans to be implemented by the system.

For example, an animal (i.e. a dog) may bark or otherwise exhibit heightened anxiety when presented with a certain triggering event, such as a car driving by. In this example, the system may employ a first machine learning model that can be trained to identify a dog's bark in sound data collected by the system, while a second machine learning model may be trained to identify the triggering event, i.e. by using a sound detection algorithm to identify the sound of the car or an object detection algorithm to identify a car in time-of-flight data collected by the sensors. A third machine learning model may be trained to match the identified behavior and triggering event, i.e. barking in response to a car going by, with a training plan in a set of one or more preconfigured training plans in the system.

In the previous example, a third machine learning model may be configured to match the behavior and triggering event (barking in response to a car going by) with a training plan stored in the system that is designed to address reactive barking. The third machine learning model can then output a signal indicating the selected plan that is needed to the system, which can then implement the training plan that was selected based on the dog's observed behavior.

In some embodiments, a machine learning model may be used to generate a custom training plan for the animal based on the first set of data. The custom training plan can then be stored in a data store of the system or in a profile associated with the animal, as will be described further below. An output can be provided at the system, such as at displays on the satellite unit 112 and/or the dispenser 123, that include the one or more training plans.

In some embodiments, the system may be configured to receive a set of training plans from a remote computing device that may be configured to communicate with processing system 405. For example, the processing system may receive the set of training plans from a cloud-based computing device configured with or executing an instance of another controller (e.g., Cloud Controller) configured to transmit, based on various criteria, the set of training plans to one or more systems, such as the systems described herein. In some embodiments, the format of training plan data received by the system may be JSON, XML, packed binary data, or other suitable formats.

The set of training programs may be updated based on various criteria using one or more machine learning models. Examples of these criteria can include whether a machine learning model determines that threshold portion of a detected behavior (i.e. a dog remaining silent for a certain number of seconds or fractions of seconds in response to a car going by) has been satisfied or not, and adjusting the threshold portion accordingly using the machine learning model.

In some embodiments, the system may collect data from the wearable device 102, satellite unit 112, and/or or dispenser 123 and may determine a performance of the animal during the training session based on the data. For example, the system may determine the successes and failures of the animal in learning the desired behavior during the training session or in the completion of various tasks during the training session. The system may adjust the length of the training sessions in the training plan, the timing of the training session, etc., using a machine learning model associated with the training plan.

For example, in the instance where a dog barks at a car going by, a machine learning model associated with a training plan may determine that the dog has more successful training sessions at a certain time of day, for instance, at night when fewer cars may be driving by. Based on the timing of the successful training sessions, the machine learning model associated with the training plan may adjust the training plan to schedule more training sessions at night. Similarly, a machine learning model associated with the training plan may determine that an animal is more successful during training sessions of a shorter duration, for instance, due to a shorter attention span of the animal. The machine learning model may then adjust the training plan to include training sessions having shorter durations. Similar criteria and considerations may be taken into account by a machine learning model in generating a custom training plan for the animal.

As mentioned previously, the metrics and/or criteria for evaluating the performance of the animal, i.e. for determining whether a training session is “successful” or not, may be adjusted by the machine learning model and may include, for example, determining whether a threshold portion of a desired behavior has been satisfied or whether the animal completed one or more tasks during the training session. For example, if an animal is to undergo scent training, the one or more tasks to be completed may be to locate various hidden objects in a training area. The system may initially require an animal to complete only one task, i.e. to locate only one object, for a training session to be considered “successful” by the system. The machine learning model associated with the training plan may then adjust the number and/or nature of the tasks to be completed by the animal based on the number of successful and failed completions of the prior tasks.

In some embodiments, once the desired behavior is offered by the animal within a sufficiently refined threshold portion or criteria, the system may assign and output a cuc for the behavior or a command for the animal. In some embodiments, the command is at least one of an audio command or a visual command, such as a light or other visible signal provided to the animal. In some embodiments, the system may be configured to transmit feedback to a computing device, which may include the one or more metrics used to evaluate the performance of the animal. For example, the computing device may be a smartphone, and the system may be configured to transmit the feedback regarding the performance of the animal to the smartphone. The feedback comprising the one or more metrics can then be displayed on a user interface of the mobile device, which may be a mobile training app, for example. Additionally, as previously mentioned, the satellite unit 112, wearable device 102, and/or the dispenser 123 may include visual displays and/or touch screens. The feedback can be displayed to the human user on one or more of these visual displays.

In some embodiments, the system may be further configured to upload the one or more training plans to a profile associated with the animal. The profile associated with the animal may be stored in a data store of the system that is accessible by the one or more machine learning models associated with the training plan. There may also be more than one profile associated with more than one animal stored on a particular system if, for example, a household has multiple pets that are trained or engaged using the system. In some embodiments, the profile associated with the animal may be stored on a remote server, i.e. a cloud server, that may be accessible by one or more external devices, Cloud Controllers, etc. such that a profile for an animal generated or updated by the systems described herein may be utilized by one or more external systems, applications, etc.

In some embodiments, the system may be configured to use the data associated with one or more profiles of different animals stored in a data store or server to train one or more machine learning models. For example, the system may use machine learning model associated with previous training sessions or plans, including those of other animals known to the Cloud Controller on other systems, to determine the optimum speed of behavioral shaping and length of sessions. The system can then store data regarding the determined optimum speed, length, etc., and can then use it to train other machine learning models.

In some embodiments, various sets of data, gathered internally by the system or gathered by external sources outside of the system, can be assigned a score (e.g. an integer score), and these scores can be aggregated to provide an animal routine score which can be associated with the profile of the animal and can be used to inform the selection or generation one or more training plans used to train the animal. Examples of external sets of data collected outside of the system that may be scored and aggregated into a routine score can include veterinary reports, genetic reports, or reports prepared by an external trainer.

For example, the external sets of data may include results of lab testing (i.e saliva, stool, blood, urine, etc), veterinary prescriptions (i.e medication names, doses, known uses, side effects and drug interactions), heart rate monitors, location sensors, mapping/GPS systems, and other databases designed for dog owners (i.e dog parks, daycares, hotels, shops, etc). External third-party data could be received by a call to the third party's API, by the third party making a call to the system's API, or by the third party sending formatted data (e.g. a CSV file.) The routine scores from the external sets of data can be aggregated with routine scores from data collected by the system during various training sessions of the animal which can be associated with the animal's profile. such that external sources of data, as well as internal sources of data collected by the systems described herein, can be used to inform the animal's training plan. In some embodiments, some or all of the internal or external data may be generated by one or more machine learning models.

For example, the system can be configured to track each activity the animal can perform (e.g., settling, spinning, hitting one or more satellite units) both during a training session and while observing unlearned natural activities of the animal. The system can keep a real-time score to determine the current preference (on a scale of 1-100, combined preference of animal+owner+trainer+vet, for example) of the animal's performance of that activity. The system may select the animal's next training plan or activity based on the highest routine score at any given time, which can change dynamically over time. For example, some breeds of dogs are more predisposed to developing hip dysplasia or other movement disorders, and this can be exacerbated by jumping. If the internal/external sources of data indicate that a dog is of a breed that is predisposed to hip dysplasia and also has a routine score reflecting a preference of jumping, the system may prioritize generating or selecting a routine that rewards the dog for not jumping so as to prevent injury.

The system may be configured to monitor the animal's mental health based on one or more data inputs to the system by the animal. This may include assessing anxiety or frustration in the animal when certain vocalizations, such as whining or barking, are detected by the system. The system may be configured to and/or designed to prioritize comfort of the animal and reduction of the animal's anxiety, while maintaining an appropriate level of challenge to mentally stimulate the animal.

The system may also monitor the animal's physical health during one or more training sessions of the one or more training plans using data collected by one or more sensors of the system, as well as data from external sources, as explained above. In some embodiments, a machine learning model may be trained to detect a change in the animal's physical health, such as a detected change in the animal's gait or heart rate based on the data collected by the one or more sensors. The system may be configured to prompt the user to contact a veterinarian in the event that a health metric deviates sufficiently from one or more baseline values for that animal or one or more default values for all animals of that species, breed, and/or type. Further, the system may be configured to adjust one or more training plans for the animal based on the detected change in gait, such as by modifying the training criteria or tasks to be completed during the training session to as to avoid exacerbating an animal's injury or health condition.

Other examples of the system using external data to inform an animal's training plan include the system receiving data from a third-party heart rate monitor, which might be used to stop a physically demanding routine for an animal. Additionally, an animal that has its cortisol levels tested via saliva sample regularly may appear to settle during a training session, yet a salivary test after the training session still shows elevated cortisol levels. The system may change the animal's training plan until lowered cortisol levels are achieved. By being able to use health data to inform an animal's training plan, this allows for an animal's training plan to be tailored to suit various underlying traits of an animal that may not be captured or seen by motion sensors or microphones alone. The system may be configured to monitor the animal's sleep cycles by analyzing data from one or more sensors associated with and/or in the wearable device 102 and alert the user to specified changes, or the system may be configured to modify the animal's training plan according to the sleep cycle data. The system may additionally monitor the animal's caloric expenditure based on data from one or more sensors associated with and/or in the wearable device 102 and may modify the animal's training plan or the reinforcements dispensed from dispenser 123 accordingly.

The system may be configured to provide the ability for the animal to choose its own activities (e.g., games, and the like) and/or to choose when to disengage from the activities (e.g., games, and the like) by providing inputs (e.g., trained inputs, predetermined inputs, defined inputs) to the system. By increasing the number of available choices to an animal, this can help increase engagement with the animal, reduce stress, and improve resiliency. As such, the system is configured and/or designed with the welfare of the animal in mind. The system, as described herein, can relieve the symptoms of separation anxiety in some animals by providing an alternate activity in the absence of human users, and by providing additional stimulation while human users are present but unable to engage with the animal.

The physical and mental welfare and wellbeing of the human users of the system can also be improved by reduction of the performance of behavior by the animal that is aversive to the human users of the system. For example, physical stress on the user may be reduced by less pulling on leash and reduction of other physically taxing and potentially dangerous activities performed by an animal that has not received sufficient training. User wellbeing may be further improved by training pet animals to remain calm and settled in human social settings that allow the presence of well-behaved pet animals, such as outdoor restaurants and coffee shops, and by training service animals to remain calm and settled in additional situations, such as in an office building or on an aircraft.

The system may be configured to monitor the animal's behavior during a manual training session by a human user, and provide feedback to the human user to assist their training program. In some embodiments, the system may be configured to allow the user to train the animal while having the system detect a target behavior and automatically provide reinforcers, allowing an easier training experience and removing barriers for human users facing physical challenges. In some embodiments, the system may be configured to allow a remote user to train an animal that is viewed on an audiovisual feed by the remote user, and automatically provide reinforcers and/or provide them on request by the remote user. The system may be configured to provide feedback through sending a notification to a user's phone or smart watch, and/or by the satellite unit, wearable device and/or dispenser being able to give audible feedback to the user.

The system may be configured to detect one or more unwanted behaviors based on detecting a behavior using one or more of the previously specified methods of behavior detection, based on comparing that detected behavior with data related to one or more behaviors stored in a database of behaviors, and based on the user's preferences of behaviors for the animal. The system may be configured to interrupt the one or more unwanted behaviors by emitting an audio and/or a visual cue, and/or by providing a reinforcer. The system may be configured to detect one or more precursor indications to one or more unwanted behaviors through the use of a trained neural network with appropriately labeled time-series data of the unwanted behavior and the antecedent behaviors.

The system may be configured to interrupt the one or more unwanted behaviors before they occur, for example, by emitting an audio and/or a visual cuc, and/or by providing a reinforcer. In some embodiments, the system may be configured to actively capture the animal's attention to prevent it from engaging in unwanted behaviors by frequently providing reinforcers. The system may be configured to train the animal to maintain longer periods of not performing unwanted behaviors between the provision of reinforcers by monitoring and adjusting a training program based on any observed increase in the animal's anxiety level resulting from an increased interval between reinforcers and/or reduced quantity of reinforcers per reinforcement cycle. Thus, the system can cause long-term positive changes in animal behavior and/or wellbeing by performing such interventions.

In some embodiments, the wearable device 102 is adapted to detect and provide data related to physiological parameters of the animal, and the controller is further configured to adjust the training plan or initiate a comforting resolution based on the physiological parameters of the animal.

In some embodiments, the physiological parameters include heart rate, respiratory rate, or temperature of the animal. In some embodiments, the comforting resolution is a reinforcer that is tailored to the physiological parameters of the animal. In some embodiments, the system (e.g., one or more processors of the system, a controller of the system, and the like) may be further configured to adjust the training plan based on data related to the animal's response to the reinforcer. In some embodiments, the adjustment to the training plan is based on an evaluation of the animal's response to the reinforcer during the training session.

In some embodiments, the system may be configured to receive data from a wearable device 102, a satellite unit 112, or a dispenser 123. The system may be configured to identify, based on the data and an output of a machine learning model, a behavior of the animal. The system may be configured to cause the dispenser 123 to release a reinforcer for the animal based on the behavior or providing one or more instructions to the animal to perform one or more additional behaviors. In some embodiments, the system may be configured to adjusting the strength or type of reinforcer based on the behavior or the animal's response to the reinforcer. In some embodiments, the system may be configured to update the machine learning model based on the animal's response to the reinforcer. In some embodiments, the strength or type of reinforcer may be adjusted based on modifying the duration, intensity, or frequency of the reinforcer. In some embodiments, the strength or type of reinforcer may be adjusted based on selecting a different type of reinforcer from a set of possible reinforcers. In some embodiments, the machine learning model may be updated based on retraining the machine learning model with data from previous training sessions.

In some embodiments, the system may be configured to generate a report of the animal's behavior during a training session and may transmit the report to a computing device associated with a human associated with the animal. In some embodiments, the report includes at least one of data related to the behavior, one or more metrics evaluating the behavior, or recommendations for future training sessions. In some embodiments, the system may be configured to generate a personalized training plan for the animal based on the animal's profile, behavior history, or other characteristics. In some embodiments, the personalized training plan may include one or more specific behaviors to be reinforced or instructions for the animal to follow.

In some embodiments, the system may be configured to detect an anomaly in the animal's behavior and may be configured to initiate a corrective action based on the anomaly. In some embodiments, the corrective action may be providing a reinforcer to the animal or providing instructions to the animal to perform a different behavior.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A system for autonomously training an animal comprising:
an input device comprising one or more sensors, wherein the input device is configured to communicate with a processing system,
wherein the system is configured to:
receive a first set of data from the input device, the first set of data comprising one or more of a pose, a linear acceleration, an angular velocity, a location, a sound, an image, a video, or magnetic field information of the animal;
transmit the first set of data to the processing system, wherein the processing system is configured with a first machine learning model trained to detect the performance of a first behavior in the first set of data, wherein the machine learning model is trained from training data comprising one or more of an animal pose, an animal linear acceleration, an animal angular velocity, an animal location, an animal sound, an animal image, or animal magnetic field information corresponding to the first behavior;
receive a signal from the processing system comprising a determination from the first machine learning model that the first behavior has been performed by the animal based on the first set of data; and
upon receipt of the signal from the processing system, cause a reward device to provide one or more of audible feedback or a reward for the animal.

2. The system of claim 1, wherein the input device comprises a wearable device.

3. The system of claim 1, wherein the system comprises the reward device.

4. The system of claim 1, wherein the reward comprises one or more of a food reward or a toy reward.

5. The system of claim 1, wherein the audible feedback comprises one or more instructions to the animal to perform one or more additional behaviors.

6. The system of claim 1, wherein the audible feedback comprises praise for the animal.

7. The system of claim 1, wherein the one or more sensors of the input device comprise at least one of a gyroscope, an accelerometer, a magnetometer, an inertial measurement unit (IMU), a microphone, a speaker, a camera, a time-of-flight (ToF) sensor, or a global positioning system (GPS).

8. The system of claim 1, wherein the one or more sensors of the input device comprise an attitude and heading reference system (AHRS).

9. The system of claim 1, wherein system is further configured to:
receive a second set of data from the input device, the second set of data comprising one or more of a second pose, a second linear acceleration, a second angular velocity, a second location, a second sound, a second image, a second video, or second magnetic field information of the animal;
transmit the second set of data to the processing system, wherein the processing system is configured with a second machine learning model trained to detect the performance of a second behavior in the second set of data, wherein the machine learning model is trained from training data comprising one or more of an animal pose, an animal linear acceleration, an animal angular velocity, an animal location, an animal sound, an animal image, or animal magnetic field information corresponding to the second behavior;
receive a signal from the processing system comprising a determination from the second machine learning model that the second behavior has been performed by the animal based on the first set of data; and
upon receipt of the signal from the processing system, cause the reward device to provide an output comprising one or more of audible feedback or a reward.

10. The system of claim 1, wherein the system comprises the processing system.

11. The system of claim 1, wherein the input device comprises the processing system.

12. The system of claim 1, wherein one or more of the input device or the processing system are configured to communicate over a wireless network.

13. The system of claim 12, wherein the wireless network is a mesh-based wireless network.

14. The system of claim 1, wherein the processing system comprises a cloud-based processor.

15. The system of claim 1, wherein the processing system comprises a computer connected to the wireless network.

16. The system of claim 1, wherein the processing system is configured to store one or more of the first set of data or data comprising the determination by the machine learning model that the first behavior has been performed by the animal to a profile associated with the animal.

17. A method for autonomously training an animal comprising:
monitoring the animal using one or more sensors;
receiving a first set of data from the one or more sensors, the first set of data comprising one or more of a pose, a linear acceleration, an angular velocity, a location, a sound, an image, a video, or magnetic field information of the animal;
inputting the first set of data into a first machine learning model, wherein the first machine learning model is trained to detect the performance of a first behavior in the first set of data from training data comprising one or more of an animal pose, an animal linear acceleration, an animal angular velocity, an animal location, an animal sound, an animal image, or animal magnetic field information corresponding to the first behavior;
determining that the first behavior has been performed by the animal from the first set of data using the first machine learning model;
upon determining that the first behavior has been performed by the animal, providing an output comprising one or more of audible feedback or a reward.

18. The method of claim 17, wherein the reward comprises one or more of a food reward or a toy reward.

19. The method of claim 17, wherein the audible feedback comprises one or more instructions to the animal to perform one or more additional behaviors.

20. The method of claim 17, wherein the audible feedback comprises praise for the animal.

21. The method of claim 17, wherein the one or more sensors comprise at least one of a gyroscope, an accelerometer, a magnetometer, an inertial measurement unit (IMU), a microphone, a speaker, a camera, a time-of-flight (ToF) sensor, or a global positioning system (GPS).

22. The method of claim 17, further comprising receiving a second set of data from the one or more sensors, the second set of data comprising a second pose, a second linear acceleration, a second angular velocity, a second location, a second sound, a second image, a second video, or second magnetic field information of the animal.

23. The method of claim 22, further comprising inputting the second set of data into a second machine learning model, wherein the second machine learning model is trained to detect the performance of a second behavior in the second set of data from training data comprising one or more of an animal pose, an animal linear acceleration, an animal angular velocity, an animal location, an animal sound, an animal image, or animal magnetic field information corresponding to the second behavior.

24. The method of claim 23, further comprising:
determining that the second behavior has been performed by the animal from the second set of data using the second machine learning model;
upon determining that the second behavior has been performed by the animal, providing an output comprising one or more of audible feedback or a reward.

25. The method of claim 17, further comprising:
determining that the first behavior has not been performed by the animal from the first set of data using the first machine learning model; and
upon determining that the first behavior has not been performed by the animal, administering a correction to the animal.

26. The method of claim 25, wherein the correction is one or more of an audible correction or a visual correction.

27. The method of claim 17, wherein determining that the first behavior has been performed by the animal from the first set of data comprises determining that a threshold portion of the first behavior has been performed by the animal using the first machine learning model.

28. The method of claim 27, wherein the threshold portion of the first behavior comprises at least one of a threshold pose, a threshold linear acceleration, a threshold angular velocity, a threshold location, a threshold sound, a threshold image, or threshold magnetic field information.

29. The method of claim 17, further comprising:
generating, based on the first set of data, one or more training plans for the animal using a third machine learning model, wherein the third machine learning model is trained to generate a training plan from training data comprising one or more of animal training plans or published behavioral science knowledge; and
providing an output comprising the one or more training plans.

30. The method of claim 17, further comprising:
selecting, based on the first set of data, one or more pre-programmed training plans for the animal using a third machine learning model, wherein the third machine learning model is trained from training data comprising one or more of animal training plans or published behavioral science knowledge; and
providing an output comprising the one or more pre-programmed training plans.

31. The method of claim 17, further comprising:
determining a first routine score for the animal based on the first set of data;
determining a second routine score for the animal based on an external set of data, wherein the external set of data comprises one or more of lab reports, veterinary reports, or trainer reports;
aggregating the first and second routine scores into an aggregate routine score; and
selecting, based on the aggregate routine score, one or more training plans for the animal.
